(19) United States
(12) Patent Application Publication
(10) Pub. No.: US 2006/0226696 A1
(43) Pub. Date: Oct. 12, 2006

(54) Self-balancing wheel

(76) Inventor: Gordon Bruce Jones, Flower Mound, TX (US)

Correspondence Address: Gordon Bruce Jones, 4400 Biscayne Drive, Flower Mound, TX, 75028, US

(21) Appl. No.: 11/093,684

(22) Filed: Mar. 30, 2005

(51) Int. Cl. B60B 27/00

(52) U.S. Cl. 301/5.22; 73/462; 73/468

(57) ABSTRACT

This invention relates to a method of balancing a rotating mass mounted on a compliant axis. This method uses acceleration vector information, extracted only from points on said mass while in motion, to determine the relocation of movable weights mounted on said mass. The shifting of these weights causes the center of gravity to coincide with the intended center of rotation which, in turn, causes the mass to be dynamically balanced.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This invention falls into the general field of balancing rotating members, and the specific field of the dynamic balancing of wheel-and-tire assemblies of moving vehicles in a continuous and instantaneous manner while said vehicle is in use and in motion. This invention may have other applications in other fields. It falls most readily into Current U.S. Classification 301/5.22.

The continuously self-adjusting dynamic balancing of rotating objects is known in the prior art. U.S. Pat. No. 3,953,074 to Cox, U.S. Pat. Nos. 4,388,841 and 6,267,450 to Gamble, U.S. Pat. No. 4,674,356 to Kilgore, U.S. Pat. No. 4,755,006 to Clay, et al., U.S. Pat. No. 5,048,367 to Knowles, U.S. Pat. No. 5,142,936 to McGale, U.S. Pat. No. 5,460,017 to Taylor, U.S. Pat. No. 5,466,049 to Harmsen, U.S. Pat. No. 5,503,464 to Collura, U.S. Pat. No. 6,719,374 to Johnson, U.S. Pat. No. 4,179,162 to Zarlengo, U.S. Pat. No. 5,073,217 to Fogal, U.S. Pat. Nos. 5,728,243, 5,766,501, and 6,129,797 to Heffeman, and U.S. Pat. No. 6,128,952 to LeBlanc all refer to systems or embodiments which incorporate weights or masses that shift their position along, or within a race or other annular path placed equidistant from the geometric center of a rotating mass. These masses are weights, weights immersed in fluids, fluids only, or some form of media. In each of these examples, these masses are allowed to move about on their own, affected only by the centrifugal forces at play in an unbalanced object.

Authors of two of these patents, McGale (in U.S. Pat. No. 5,142,936) and Johnson (in U.S. Pat. No. 6,719,374) refer to an Apr. 28, 1965 article published in “Design News” that outlines the four conditions which must occur in order to take advantage of their art. In the second of these four requirements, McGale states “the rotating part must operate above its critical speed”, and, in slightly different words, Johnson cautions “the rotating system must operate far and away from its critical or resonant speed”. It is widely known that in automotive applications the resonant speed of a wheel assembly typically falls between 55 mph and 75 mph. This is the speed at which imbalances are noticed and reported. If the tenets of the Design News article are to be believed, then one must question the usefulness of an art whose design prohibits its use at the very speeds at which they are most needed.

U.S. Pat. No. 4,179,162 to Zarlengo, U.S. Pat. No. 5,073,217 to Fogal, U.S. Pat. Nos. 5,728,243, 5,766,501, and 6,129,797 to Heffernan, and U.S. Pat. No. 6,128,952 to LeBlanc all refer to systems or embodiments in which the balancing medium or mass is placed directly into the tire cavity. These media are typically comprised of glass beads, silica, small metal beads, or some other finely divided solid material. These all claim to provide some balancing effect. One disadvantage of this art is that the media can be displaced under conditions of high lateral or vertical loads. These occur when the wheel locks up on braking or when the tire strikes an object in the road. Another disadvantage of this art is maintenance. The media must be handled, if not outright replaced with every tire change. The proposed invention has no maintenance, and is not affected by adverse loads.

None of the above named authors volunteer scientific explanations for the means by which the mass or media migrate to their needed positions. Of those that attempt an explanation, Collura (in U.S. Pat. No. 5,503,464) offers: “. . . fluids will substantially instantaneously counteract imbalances . . . ”, LeBlanc (in U.S. Pat. No. 6,128,952) offers: “an opposite force is created . . . ”, and “. . . the motion . . . encourages the . . . material to migrate . . . ”, and Taylor (in U.S. Pat. No. 5,460,017) concedes: “It is difficult to precisely state the principle by which the balls move”. The author of this invention will clearly state, and in great detail, the principle by which this invention works.

### BRIEF SUMMARY OF THE INVENTION

It is the object of this invention to dynamically balance rotating objects while in motion, in a method unlike all other previous art, while simultaneously overcoming all of the previous art's shortcomings.

This invention is a method, or process. It is the process of using acceleration vectors, taken from various points on a wheel in motion, to govern the positions of movable wheel weights, with the result of providing for a dynamically balanced wheel. This process may be applied to any rotating mass mounted on a compliant axis.

This invention overcomes all the previous art's disadvantages in that it will have no limitations due to speed. It is unaffected by how many times a tire is changed. There is no maintenance. Sudden changes in load have no adverse effect on the mechanism of this invention. This invention is based on existing science that affords precise, quantifiable and controlled results. And lastly, the cost of this invention over the life of the vehicle is low.

### BRIEF DESCRIPTION OF THE SEVERAL VIEWS OF THE DRAWINGS

FIGS. 1A and 1B are of geometric models.

FIG. 2 is of a sensor assembly.

FIG. 3 is an external view of a self-powered wheel weight.

FIG. 3A is the cross-section of FIG.3 taken across the middle.

FIG. 3B is a cross-section of FIG. 3 taken lengthwise.

FIG. 4 is a general view of a wheel utilizing the first embodiment.

FIG. 4A is a cross-section of FIG. 4.

FIG. 4B is a cross-section of FIG. 4A.

FIGS. 5A and 5B are of FIG. 4 in plan view, with geometric model overlay.

FIG. 6 is an exterior view of a general wheel utilizing the second embodiment.

FIG. 6A is a cross-section of FIG. 6.

FIG. 6B is another cross-section of FIG. 6.

FIG. 7 is a view of balancing cylinder used in second embodiment.

FIG. 7A is a cross-section of FIG. 7.

FIG. 7B is another cross-section of FIG. 7.

FIG. 8 is an exploded view of a third embodiment.

FIG. 8A is a cross-section of a FIG. 8.

### DETAILED DESCRIPTION OF THE INVENTION

In order to better understand the proposed invention, a knowledge of centripetal force and simple geometry is required. Centripetal force is a force of acceleration. It is also, by definition, the force required to maintain an object in a circular path around a point. This force, or vector, acts perpendicular to the instantaneous path of the object, and directly toward the point.

Consider now a rotating mass, mounted on a compliant axis. A compliant axis is one that is not rigid in space; it will deform under forces applied to it. For example, a merry-go-round is mounted on a rigid axis, whereas an automotive wheel is mounted on a compliant one.

Consider now, instead of a rotating mass, a circle represented by a very large group of separate coordinates, or loci, in a circular path around point in paragraph one. All loci on the mass experience a centripetal force vector, with all vectors directed toward the aforementioned point, which from henceforth shall be referred to as the point of rotation.

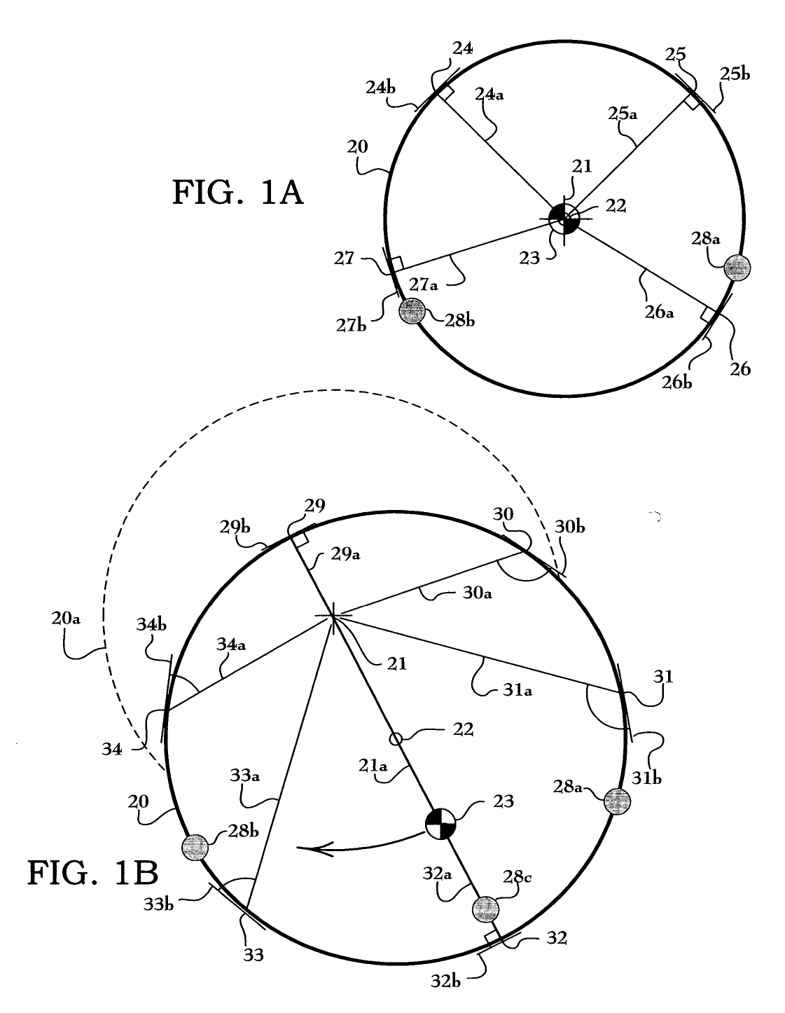

Referring now to FIG. 1A, circle 20 represents aforementioned rotating mass, or wheel, in dynamic balance. Weights 28a and 28b are movable weights, whose current positions place the wheel in the balanced condition. Crosshairs 21 represent the point of rotation, circle 22 represents the physical center of the wheel, and symbol 23 represents the center of gravity. Points 24 through 27 are sample loci. Lines 24a through 27a represent the vector of each locus 24 through 27, respectively. Lines 24b through 27b represent the tangent of each locus, respectively. Note that in this balanced condition all vectors are perpendicular to their respective tangents. Accordingly, center of wheel 22, center of gravity 23 and point of rotation 21 are collocated.

Refer now to FIG. 1B, an exaggerated depiction of an out-of-balance condition. Dotted circle 20a represents previous position of normally-balanced circle 20. Center of gravity (c.g.) 23 has been displaced from center of wheel 22 by the addition of fixed weight 28c. Since circle 20 is mounted on a compliant axis, the offset c.g. 23 pulls center of wheel 22 away from center of rotation 21. Note that weight 28c, c.g. 23, center of wheel 22, and center of rotation 21 all lie on line of stasis 21a, which bisects circle 20 at loci 29 and 32. Observe now loci 29 through 34, with respective vectors 29a through 34a and tangents 29b through 34b. Loci 29 and 32 lie on stasis line 21a. Vectors 29a and 32a also lie on stasis line 21a, and are therefore perpendicular to their respective tangents.

All other possible loci on circle 20, including 30, 31, 33 and 34, produce non-perpendicular vectors. It is no coincidence that these vectors always face toward center of rotation 21, and away from c.g. 43.

Now, in order to return any rotating mass to a balanced state, weight must be added, subtracted, or rearranged. In the case of this invention, only rearrangement is considered. Weights 28a and 28b are the weights considered for this task, and it must now be determined which direction to move them, either clockwise or counterclockwise. Since the center of gravity of any whole mass shifts in the same direction as any moving part of the mass, and it is desired to shift c.g. 23 toward center of rotation 21, then weight 28a must shift clockwise, and 28b counter-clockwise. It is not a coincidence that this is also the orientation of all vectors on either side of stasis line 21a. Based on this fact—that the acceleration vectors will always point in the direction of balance correction—all that is needed to balance rotating masses on compliant axes are 1) methods of measuring acceleration vectors, and 2) methods of driving self-powered wheel-balancing weights using this vector information.

Measuring vectors of acceleration is a common process. From the simplest carpenter's level, to tools incorporating lasers, the means to measure vectors of acceleration, the most commonly referenced of which is earth's gravity, are all around us. For ease of comprehension a simple pendulum is used in the following illustrated embodiments. The process of directing self-powered weights is also relatively simple and common, and can be performed by a small computer, a small electric motor, and a small power supply.

It is hereby stressed that although only one device for measuring vectors of acceleration is named below, any device that measures acceleration can and should be considered as being useful in the method of this invention. Similarly, only one means of turning a shaft is named below, but any device of mechanical propulsion should be considered as being useful in the method of this invention.

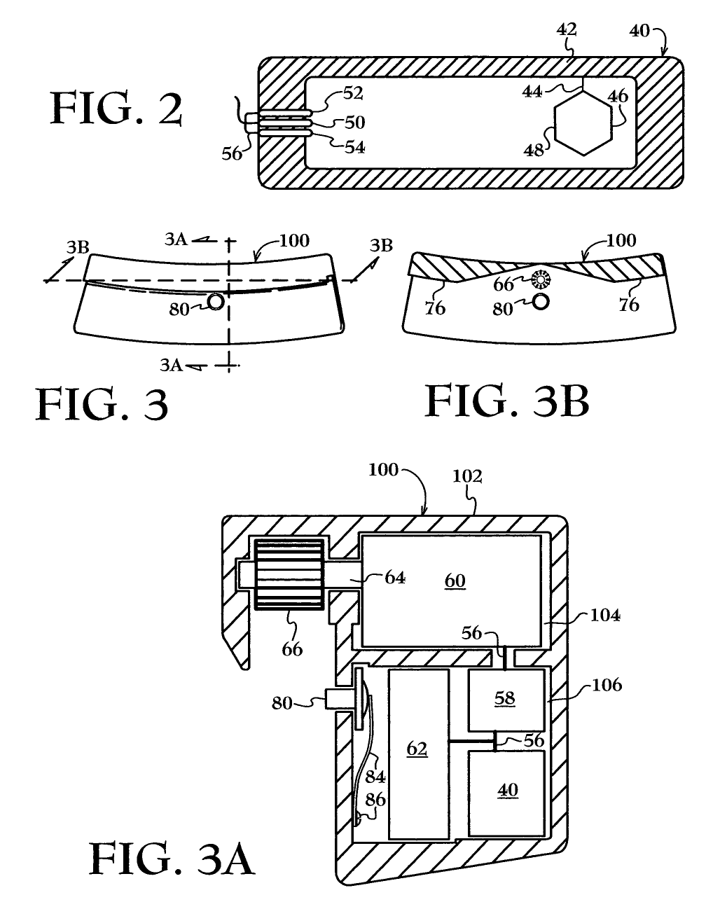

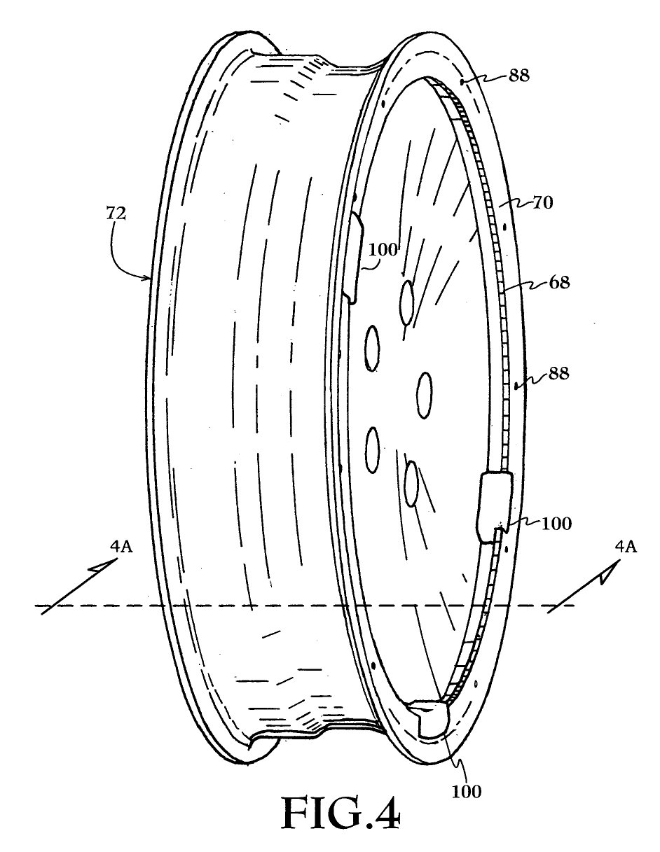

Now, turning once again to the drawings, FIG. 2 shows sensor assembly 40, a device for measuring acceleration vectors. Beginning with case 42, to the inside a thin metal strip 44 is securely fastened. Firmly attached to end of strip 44 is pendulum 46. On one side of pendulum 46 is reflective surface 48. Directing a beam of light at surface 48 is light 50, and on either side of light 50 are sensors 52 and 54. Pendulum 46 is configured so that when it senses an acceleration vector perpendicular to its tangent, it will reflect light substantially back to light 50, and equally toward sensor 52 and sensor 54. When the acceleration vector is not perpendicular, pendulum 46 will reflect light more towards either sensor 52 or sensor 54, depending on the direction of the acceleration vector. Sensors 52 and 54, and light 50 are connected through wires 56 to computer 58 in FIG. 3A. Computer 58 is connected to electric motor 60 through wires 56. Power source 62, through wires 56, supplies power to computer 58, light 50, sensor 52, sensor 54, and motor 60.

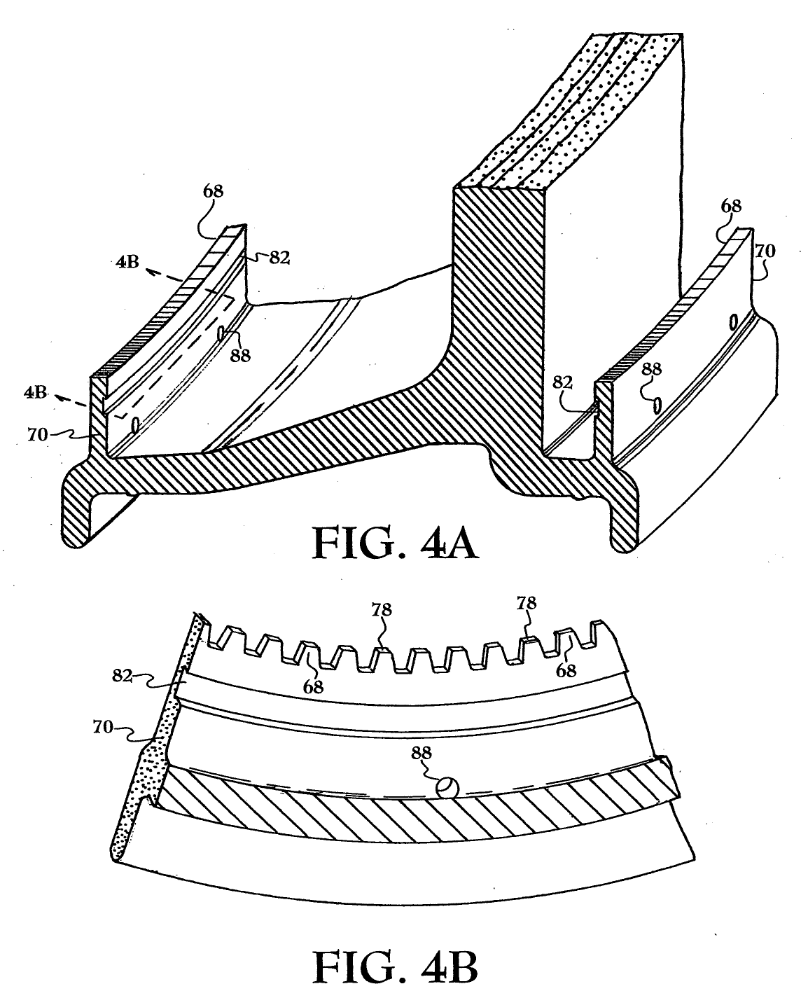

Electric motor 60 drives gear 66 by means of shaft 64. Gear 66 engages ring teeth 68 in FIG. 4B, which are cut into annular track or race 70. Referring to FIGS. 4, 4A, and 4B, annular race 70 is machined into wheel 72. Computer 58 is programmed to have motor 60 drive weight 100 around race 70 in the same direction as the acceleration vector, as sensed by pendulum 46. When the acceleration vector is perpendicular, weight 100 does not move.

Additional explanations of relationships of this embodiment are as follows: Referring to FIGS. 3, 3A and 3B, self-powered balancing weight 100 is comprised of case 102, with chambers 104 and 106. Motor 60 resides in chamber 104. Computer 58, sensor assembly 40, and power source 62 reside in chamber 106. Referring simultaneously to FIG. 4B, landings 74 rests on the tops 76 of ring teeth 68, and button 78 engages slot 80. Button 78 is held under tension by spring 82. Spring 82 is secured by screw 84. Holes 86, equally spaced on race 70, can be seen in FIGS. 4, 4A, and 4B, and provide for drainage.

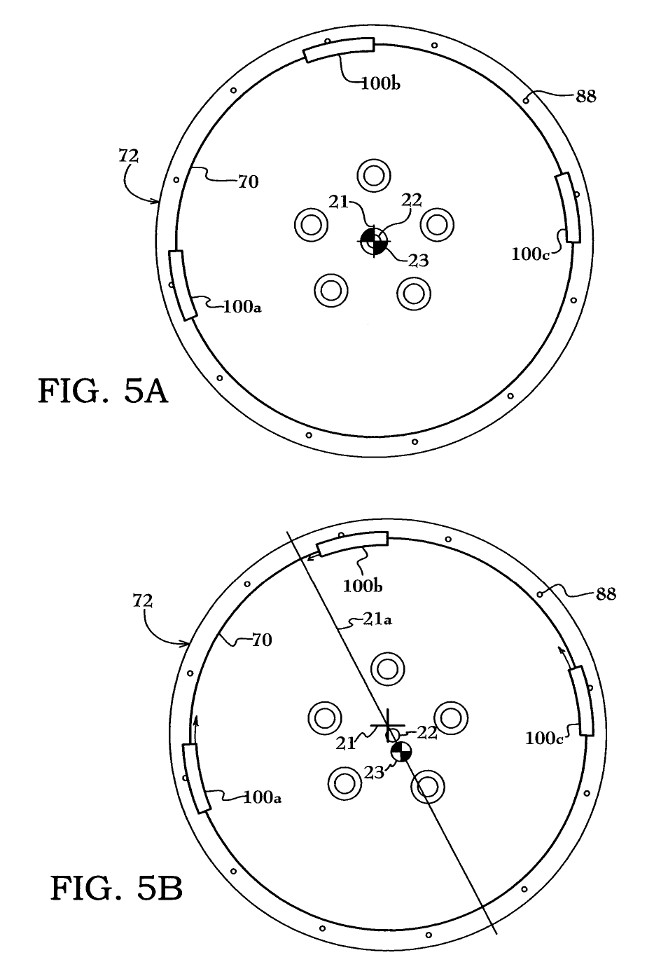

A description of the dynamics of this embodiment will now be undertaken. Refer to FIG. 5A of wheel 72, with three identical balancing weights, labeled 100a, 100b, and 100c. Weights 100a, b and c are in random positions along race 70, and wheel 72 is in a balanced state. Since the wheel is balanced, all acceleration vectors are perpendicular to their tangents, and all weights are dormant.

Refer now to FIG. 5B, where an imbalance has developed in wheel 72. The acceleration vector for weight 100c has shifted to its right. The same can be said for weight 100b, though to a much lesser degree. Since weight 100a lies on the other side of stasis line 21a, its acceleration vector has shifted to its left. Since each weight has been configured to follow its respective vector, weight 100c will shift counterclockwise, 100b will do likewise, but to a lesser degree, and 100a will shift clockwise. This process will continue until c.g. 23 and center of rotation 21 once again converge, and wheel 72 has been restored to a balanced condition.

The second embodiment utilizes the method of moving the weight radially, instead of tangentially, to influence a center of gravity. The changes in vectors of acceleration produced by this method are best detected from a locus not at the weight in question, but from a point that is 45 to 135 degrees relative to the motion produced by such a shift. Since this requires separating the weight and the sensor that governs it, a means of communication between them must be used. In this embodiment, this is accomplished using a small transceiver, incorporated into computer 58, now referred to as computer 58a.

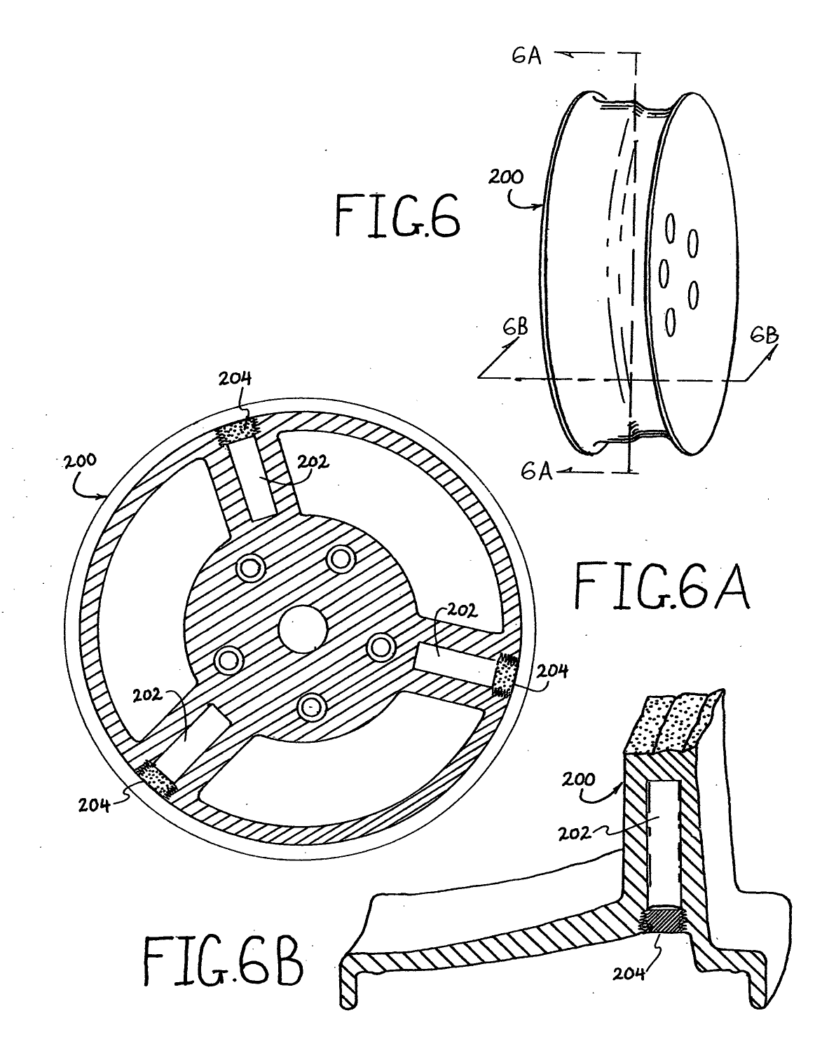

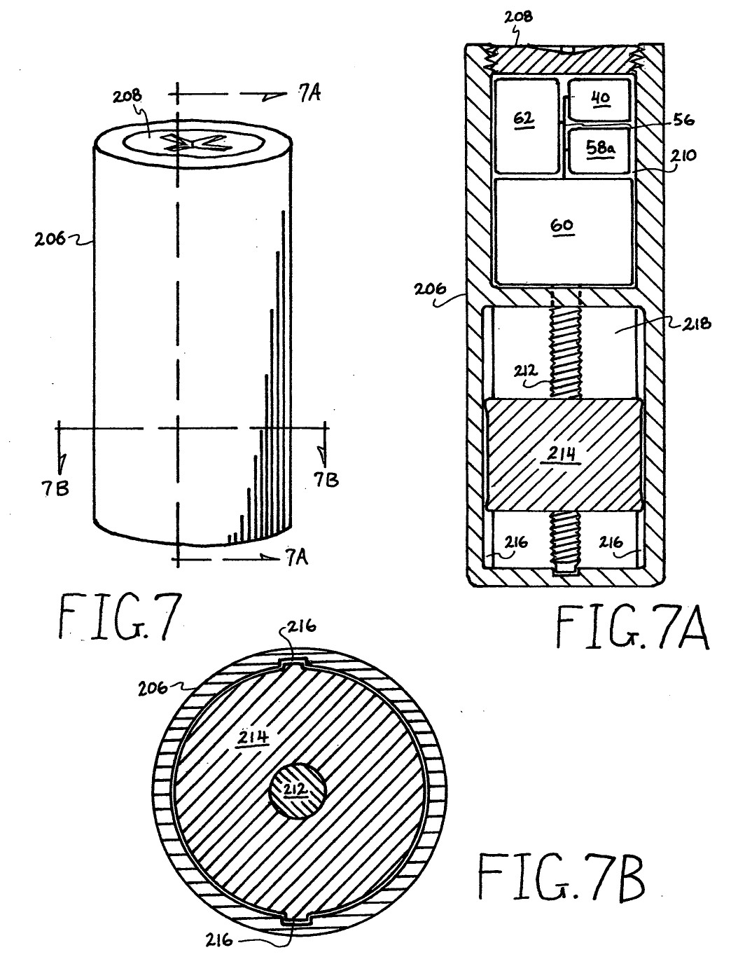

Refer now to FIG. 6, a general view of a typical wheel 200 utilizing the second embodiment. Shown in FIGS. 6A and 6B is cylindrical cavity 202, and threaded plug 204, which seals off cavity 202, into which cylinder 206 fits. FIG. 7 is of cylinder 206, with smaller threaded plug at the top referred to as permanent plug 208. Referring to FIG. 7A, just below permanent plug 208 is chamber 210. Inside chamber 210 is sensor assembly 40. Through wires 56, sensor assembly 40, computer 58a, and power source 62 are connected to motor 60. Motor 60 drives threaded shaft 212. Counterbalance 214 rides on shaft 212, and is kept from rotating by slots 216. Shaft 212, counterbalance 214 and slots 216 are within chamber 218. FIG. 7B, a cutaway of chamber 218, shows more clearly the relationship between counterbalance 214 and slots 216.

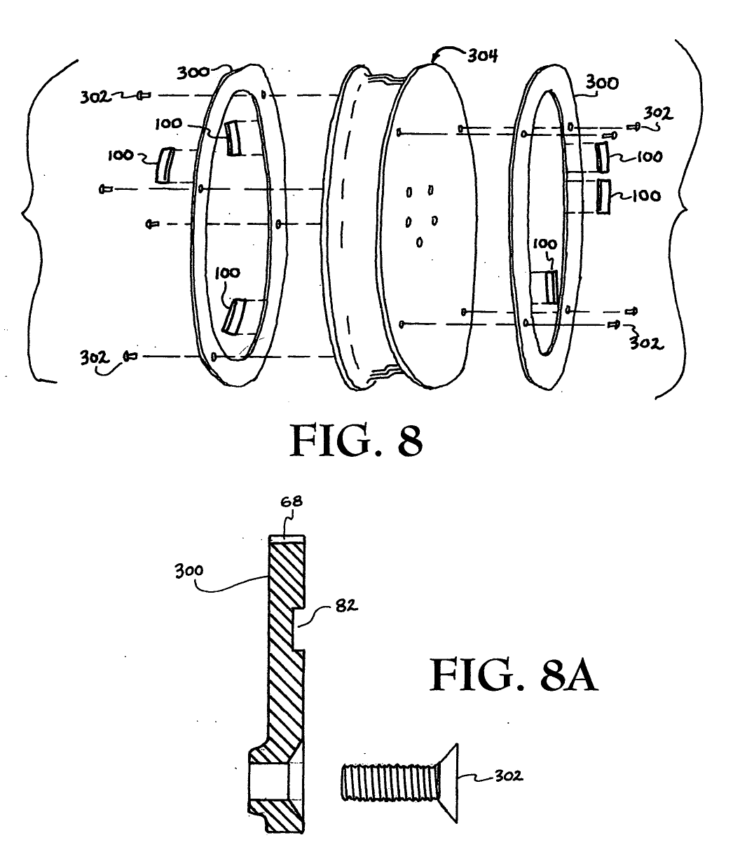

FIG. 8 illustrates a retro-fit kit of the first embodiment. Kit is comprised of rings 300, fasteners 302, and weights 100. The rings 300 are securely attached to a typical automotive wheel 304 in a concentric manner using fasteners 302. Weights 100 mount on rings 300 in the same manner as with race 70, and function in the same manner as in the first embodiment.

1. A method for dynamically balancing a rotating member about a compliant axis comprising the steps of:
a) detecting and quantifying, from locations on said member, vectors of acceleration, and
b) using said vectors to re-position self-powered balancing weights about said member,
c) whereby said rotating member will achieve a state of dynamic balance.

2. A self-balancing rotating assembly comprised of
a) a rotating member mounted on a compliant axis,
b) a plurality of sensors mounted in or on said member, each of which detects and measures vectors of acceleration,
c) a plurality of self-powered balancing weights which, using said vectors, reposition themselves about said member.

3. A wheel-balancing kit for installation on a vehicle wheel comprising:
a) one annular ring which is affixed to said wheel in a circumferential manner,
b) not less than two but not more than three sensors, each of which detects and measures vectors of acceleration,
c) not less than two but not more than three self-powered balancing weights, each said weight corresponding to only one said sensor, and each said sensor corresponding to only one said weight.

4. A wheel-balancing kit for installation as in claim 3 wherein the numbers of said annular rings, sensors and weights are doubled, with the duplicate set of components being mounted in said circumferential manner, but on a plane substantially different from the first.
